(19) United States
(12) Patent Application Publication
(10) Pub. No.: US 2013/0284661 A1
(43) Pub. Date: Oct. 31, 2013

(54) Housing for Filter and Filter

(71) Applicant: MANN+HUMMEL GMBH, Ludwigsburg (DE)

(72) Inventors: Yongnan Tan, Shanghai (CN); Vinson Jia, Shanghai (CN)

(73) Assignee: MANN+HUMMEL GMBH, Ludwigsburg (DE)

(21) Appl. No.: 13/871,800

(22) Filed: Apr. 26, 2013

(30) Foreign Application Priority Data
Apr. 26, 2012 (CN) 201210125724.X

(51) Int. Cl. B01D 27/08

(52) U.S. Cl. CPC B01D 27/08
USPC 210/435; 210/541

(57) ABSTRACT

A housing for a filter element includes a fluid inlet and a deflector arrangement leading the fluid to be filtered towards the filter element. The invention further relates to a filter including a housing; a filter element arranged within the housing and dividing the space inside the housing into a first and second chamber, the inlet in communication with the first chamber. Pressure loss is advantageously reduced due to the deflector arrangement Meanwhile, by distributing the deflecting parts of said deflector arrangement evenly, the uniformity of velocity at the surface of filter element is also improved, while the occurrence of inefficiency of filtration or the like decreases.

### FIELD OF THE INVENTION

The present invention relates to a device for removing impurities from fluids; more particularly, the invention relates to a housing for a filter element and furthermore relates to a filter.

### BACKGROUND

Filters are widely used in various areas.

For example, in the automobile industry, four filters are usually provided in an automobile, i.e., the air filter, oil filter and fuel filter in the engine as well as air conditioner filter in the cabin. These filters respectively serve to filter mediums in the engine intake system, lubrication system, combustion system and cooling system.

FIG. 1 illustrates a common structure of an air filter in the prior art. As can be seen from the figure, the air filter mainly consists of two portions, a housing 1 and a filter element 2; the arrow in the figure designates the flow direction of air, that is, the feeding air flows enters the housing 1 and the filter element 2 via an air inlet 3 and flows out from an air outlet 4 as cleaned air after being purified by the filter element 2.

The normal functioning of the air filter is critical to the normal operating of devices. For example, since the engine of automobile is an extreme precision component and tiny impurities can damage the engine, air must be first finely filtered by the air filter before entering cylinders. Whether the condition of the air filter is good or bad has an influence on the service life of the engine; if an overly dirty air filter is used when the automobile is travelling, the engine will intake insufficient air and the fuel will not combust completely, thus making the engine operate unstably, lowering power and leading to increase of the amount of fuel consuming.

Description is given herein with the air filer in automobile engine as an example; it will be understood that this example is used to explain the common importance of filters in various applications.

There exists need to overcome the aforesaid technical problems and improve the prior designs in the art.

### SUMMARY OF THE INVENTION

The technical problem to be solved by the invention is to provide a housing for a filter element, which housing can reduce pressure loss and improve the uniformity of velocity at the filter element surface.

Furthermore, the invention also provides a filter for purifying fluids.

The aforesaid technical problems are solved by the following technical solutions:
according to a first aspect of the invention, a housing for a filter element for filtering a fluid is provided, the housing having an inlet for the fluid to be filtered, wherein the inner wall of the housing is provided with a deflector arrangement for leading the fluid to be filtered towards the filter element. The housing for a filter element arranged in such a manner leads the fluid to be filtered towards the filter element and can effectively reduce pressure loss and improve the uniformity of velocity at the filter element.

Optionally, in the above-described housing, the deflector arrangement includes protrusions arranged on the inner wall of the housing, which protrusions extend in the longitudinal direction of the housing and at least pass the longitudinal position corresponding to the inlet for fluid to be filtered. The housing for a filter element embodied in such a manner can advantageously lead the fluid coming from the inlet for fluid to be filtered while simplifying structure and saving manufacture cost to the greatest possibility.

Optionally, in the above-described housing, side faces of the protrusions which face the fluid coming from the inlet for fluid to be filtered are tangent to the inner wall of the housing. The housing for filter embodied in such a manner can maximally realize the deflecting effect and lower pressure loss.

Optionally, in the above-described housing, the housing is of a cylindrical shape, the tangent lines where the side faces of the protrusions which face the fluid coming from the inlet for fluid to be filtered are tangent to the inner wall of the housing, as well as the generatrix line of the housing which intersects with the center line of the inlet for fluid to be filtered, are evenly distributed on the circumference of the housing. The housing for filter arranged in such a manner can realize deflecting of fluid to be filtered at various portions of the filter, thus maximally lowering pressure loss and improving uniformity of velocity at the filter element surface.

Optionally, the protrusions gradually increase in height in a main flow direction of the fluid coming from the inlet of the housing.

The second aspect of the invention provides a filter for purifying fluid, wherein the filter comprises:
a housing;
a filter element which is arranged within the housing, dividing the space inside the housing into a first chamber and a second chamber which are located on different sides of the filter element, wherein the first chamber is located between the housing and the filter element; and
an inlet for fluid to be filtered in communication with the first chamber and an outlet for filtered fluid in communication with the second chamber, wherein,
a deflector arrangement for leading fluid to be filtered towards the filter element is provided in the first chamber.

Optionally, in the above-described filter, the deflector arrangement includes protrusions arranged on the inner wall of the housing, which protrusions extend in the longitudinal direction of the housing and at least pass the longitudinal position corresponding to the inlet for fluid to be filtered of the filter.

Optionally, in the above-described filter, side faces of the protrusions which face the fluid coming from the inlet for fluid to be filtered are tangent to the inner wall of the housing.

Optionally, in the above-described filter, the housing is of a cylindrical shape, the tangent lines where the side faces of the protrusions which face the fluid coming from the inlet for fluid to be filtered are tangent to the inner wall of the housing, as well as the generatrix line of the housing which intersects with the center line of the inlet for fluid to be filtered, are evenly distributed on the circumference of the housing.

Optionally, in the above-described filter, the inlet for fluid to be filtered is tangent to the housing.

Optionally, said protrusions gradually increase in height in a main flow direction of the fluid coming from the inlet.

As can be seen, in the above-described housing for a filter element and corresponding filter in accordance with the invention, due to the provision of a deflector arrangement for leading fluid to be filtered towards the filter element, pressure loss is effectively reduced; besides, due to the even distribution of these defectors, uniformity of velocity at the filter element surface and filtering efficiency of the filter are improved, and the service life of filter is lengthened.

### BRIEF DESCRIPTION OF THE DRAWINGS

The disclosure of the invention will become more apparent with reference to the accompanying drawings. It will be understood that the accompanying drawings are for schematic purpose only, not drawn to scale and not intended to limit the scope of the invention. In the drawings:

FIG. 1 is a schematic view of a filter in the prior art; and

FIG. 2 is a schematic view of a housing for a filter element according to the invention.

### DETAILED DESCRIPTION OF THE INVENTION

The particular embodiments of the invention will be described hereinafter with reference to the accompanying drawings.

FIG. 2 is a schematic view of a housing for a filter element according to the invention. As shown in the figure, in order that the fluid to be filtered flows smoothly and reaches the surface of filter element at a uniform velocity, the housing 1 for a filter element in accordance with the embodiment shown in the figure is of a cylindrical shape, and a deflector arrangement comprising three deflectors for leading the fluid to be filtered towards the filter element 2 of the filter are provided on the inner wall of the housing. The three deflectors can lead the fluid to be filtered from fluid inlet 3 to filter element surface simultaneously, thus promoting flow of fluid through filter element 2 to be filtered. The number of deflectors of the deflector arrangement is not limited to three; another number of deflectors is also possible.

In the figure, the deflectors are protrusions 11 arranged on the inner wall of the housing 1. In order to realize the deflecting effect throughout the inner wall of the housing 1, the protrusions 11 may extend in the entire longitudinal direction of the housing 1. It will be understood that in an alternative embodiment, the protrusions 11 may also at least run over the longitudinal position corresponding to the inlet 3 for fluid to be filtered of the filter without having to extend through the entire longitudinal direction of the housing 1. Such an arrangement can realize a well-defined deflecting effect while simplifying structure and saving cost.

In order to reduce fluid resistance caused by the protrusions when performing deflection, side faces of the protrusions 11 which face the fluid coming from the inlet 3 for fluid to be filtered are tangent to the inner wall of the housing 1 so that the fluid can smoothly flow towards the deflecting surface of the protrusions 11 so as to be deflected. Meanwhile, in order to realize a uniform fluid deflection on the entire circumference of the housing, the tangent lines where the side faces of the protrusions 11 are tangent to the inner wall of the housing 1, as well as the generatrix line of the housing 1 which intersects with the center line of the inlet 3 for fluid to be filtered, are evenly distributed on the circumference of the housing 1.

The protrusions 11 may gradually increase in height in a clockwise direction beginning at the location of the inlet 3 for fluid.

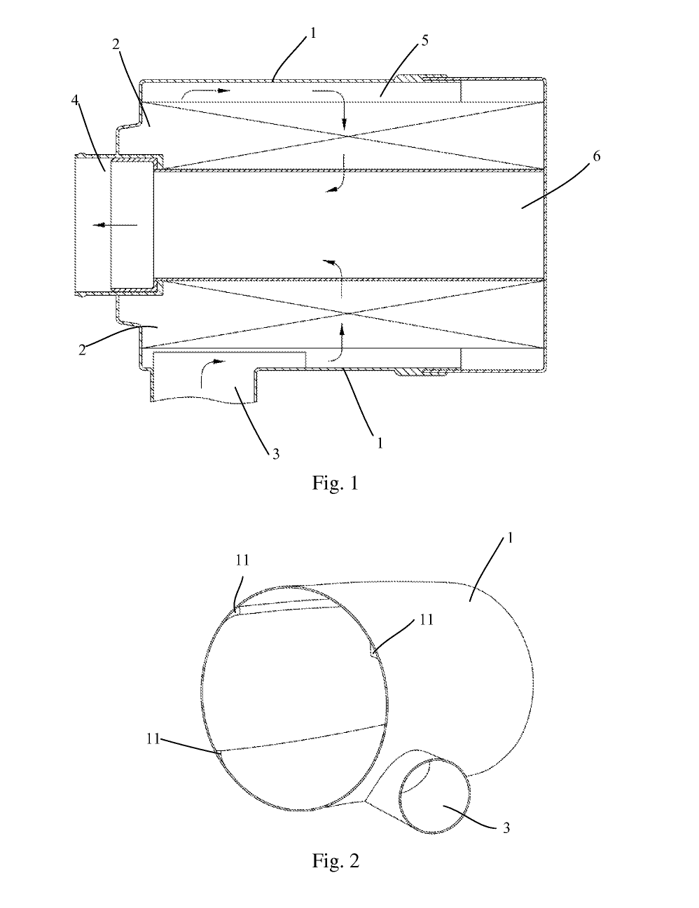

A filter in accordance with an embodiment of the invention which is advantageously provided with a deflector arrangement will be derived when combining FIG. 1 with FIG. 2; the filter having fluid deflecting function will be described specifically hereinafter.

As can be seen, the filter comprises a housing 1, a filter element 2 arranged within the housing 1, an inlet 3 for fluid to be filtered and an outlet 4 for filtered fluid. As can be understood from the figure, in order that the fluid to be filtered flows smoothly and reaches the surface of filter element 2 at a uniform velocity, the housing 1 is of a cylindrical shape and the inlet 3 for fluid to be filtered is tangent to the cylindrical housing 1. The filter element 2 is arranged within the housing 1 and divides the space inside the housing 1 into a first chamber 5 and a second chamber 6 which are located on different sides of the filter element 2, wherein the first chamber 5 is in communication with the inlet 3 for fluid to be filtered and is located between the housing 1 and the filter element 2, the fluid to be filtered flows through the filter element 2 to be filtered after being deflected in the first chamber 5, and the second chamber 6 is located on the other side of the filter element 2 and is in communication with the outlet 4 for filtered fluid so that the filtered fluid can flow away from the filter smoothly.

In order to reduce pressure loss and improve the uniformity of velocity at the filter element surface, a plurality of deflectors for leading the fluid to be filtered towards the filter element 2 are provided inside the first chamber 5 (preferably provided on the inner wall of the housing 1). For example, the deflectors can be protrusions 11 arranged on the inner wall of the housing 1 as shown in FIG. 2. In order to realize the deflecting effect throughout the inner wall of the housing 1, the protrusions 11 may extend in the entire longitudinal direction of the housing 1. However, it will be understood that in an alternative embodiment, the protrusions 11 may at least pass the longitudinal position corresponding to the inlet 3 for fluid to be filtered of the filter without having to extend through the entire longitudinal direction of the housing 1. Such an arrangement can realize a well-defined deflecting effect while simplifying structure and saving cost.

In order to reduce fluid resistance caused by the protrusions when performing deflection, side faces of the protrusions 11 which face the fluid coming from the inlet 3 for fluid to be filtered are tangent to the inner wall of the housing 1 so that the fluid can smoothly flow towards the deflecting surface of the protrusions 11 so as to be deflected. Meanwhile, in order to realize a uniform fluid deflection on the entire circumference of the housing, the tangent lines where the side faces of the protrusions 11 are tangent to the inner wall of the housing 1, as well as the generatrix line of the housing 1 which intersects with the center line of the inlet 3 for fluid to be filtered, are evenly distributed on the circumference of the housing 1. The protrusions 11 may gradually increase in height one by one in a clockwise direction, beginning at the location of the inlet 3 for the fluid to be filtered.

As described above, an exemplary embodiment of the invention has been described in detail with reference to the accompanying drawings. It should be understood that the application is not intended to limit the scope of protection of the invention with these particular details.

The structure and features of the above-described embodiment can be modified equivalently or similarly without departing from the spirit and scope of the invention, and these modifications will also fall within the scope of protection of the invention defined by the appended claims.

I claim:

1. A housing for a filter element for filtering fluids, comprising:
an inlet for the fluid to be filtered;
a chamber for receiving the filter element;
a deflector arrangement provided on an inner wall said chamber, said deflector arrangement operable to lead or guide the fluid to be filtered towards said filter element.

2. The housing according to claim 1, wherein
said deflector arrangement includes protrusions arranged on an inner wall of the housing and protruding into said chamber;
wherein said protrusions extend in a longitudinal direction of the housing and at least pass through a longitudinal position corresponding to the inlet for fluid to be filtered.

3. The housing according to claim 2, wherein
side faces of the protrusions which face the fluid coming from the inlet for fluid to be filtered are arranged tangent to said inner wall of the housing.

4. The housing according to claim 3, wherein
said housing is of a cylindrical housing;
wherein the tangent lines where the side faces of the protrusions which face the fluid coming from the inlet for fluid to be filtered are tangent to the inner wall of the housing as well as a generatrix line of the housing which intersects with a center line of the inlet for fluid to be filtered, are evenly distributed on the circumference of the housing.

5. The housing according to one of the claim 2, wherein
said protrusions gradually increase in height in a main flow direction of the fluid coming from the inlet.

6. A filter for purifying fluid, comprising:
a housing;
a filter element which is arranged within the housing, dividing the space inside the housing into a first chamber and a second chamber which are located on different sides of the filter element;
wherein the first chamber is located between the housing and the filter element; and
an inlet for fluid to be filtered in communication with the first chamber; and
an outlet for filtered fluid in communication with the second chamber;
wherein a deflector arrangement for leading fluid to be filtered towards the filter element is provided in the first chamber.

7. The filter according to claim 6, wherein
the deflector arrangement includes protrusions arranged on the inner wall of the housing, which protrusions extend in a longitudinal direction of the housing and at least pass the longitudinal position corresponding to the inlet for fluid to be filtered.

8. The filter according to claim 7, wherein
side faces of the protrusions which face the fluid coming from the inlet for fluid to be filtered are tangent to the inner wall of the housing.

9. The filter according to claim 8, wherein
the housing is a cylindrical housing;
wherein the tangent lines where the side faces of the protrusions which face the fluid coming from the inlet for fluid to be filtered are tangent to the inner wall of the housing, as well as a generatrix line of the housing which intersects with a center line of the inlet for fluid to be filtered, are evenly distributed on the circumference of the housing.

10. The filter according to any one of claim 6, wherein
the inlet for fluid to be filtered is arranged tangent to the housing.
